(19) United States
(12) Patent Application Publication
(10) Pub. No.: US 2010/0273055 A1
(43) Pub. Date: Oct. 28, 2010

(54) LITHIUM-ION ELECTROCHEMICAL CELL

(75) Inventors: Junwei Jiang, Woodbury, MN (US); Zhonghua Lu, Woodbury, MN (US); Matthew Triemert, Minneapolis, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/431,028

(22) Filed: Apr. 28, 2009

(51) Int. Cl. H01M 4/00; H01M 4/58

(52) U.S. Cl. 429/223; 29/623.1; 429/231.95

(57) ABSTRACT

Lithium-ion electrochemical cells are provided that have high charge-discharge rates, excellent thermal stability and low irreversible capacity. The provided cells include a lithium mixed metal oxide cathode and a lithium titanate anode. The lithium mixed metal oxide cathode has cobalt as its major constituent.

### FIELD

This disclosure relates to lithium-ion electrochemical cells.

### BACKGROUND

Secondary lithium-ion electrochemical cells typically include a positive electrode that contains lithium in the form of a lithium transition metal oxide, a negative electrode, and an electrolyte. Examples of transition metal oxides that have been used for positive electrodes include lithium cobalt dioxide and lithium nickel dioxide. Other exemplary lithium transition metal oxide materials that have been used for positive electrodes include mixtures of cobalt, nickel, and/or manganese oxides. Negative electrodes typically include graphite or lithium composites that can include Si, Ti, Sn, Al, Ga, Ge, In, Bi, Pb, Zn, Cd, Hg, and Sb which are electrochemically active.

The challenges in designing lithium-ion electrochemical cells include obtaining a balance between high capacity, high charge-discharge rates, low irreversible capacity, cost, and safety. Lithium cobalt oxide (LiCoO₂) is widely used as positive electrode materials in commercial products such as computers and hand held phones. LiCoO₂ can have high capacity due to its high density, rapid charge-discharge due to its layered structure, low irreversible capacity, but also is expensive and is subject to occasional runaway thermal reactions. To temper the expense and safe performance of this material, manganese and nickel can be added to the LiCoO₂ structure to replace some of the cobalt. However, when the amount of cobalt in these lithium mixed metal oxides is reduced, the materials exhibit higher irreversible capacity in their initial charge-discharge cycle.

### SUMMARY

There is a trend in the electronics industry in the direction of more compact electronics requiring higher power density. Thus, there is a need for electrochemical cells or batteries that include electrochemical cells that are compact, have high energy density, low irreversible capacity, and good safety properties such as thermal stability. One way to fill this need is to design lithium-ion electrochemical cells that have the combination of a positive electrode material and a negative electrode material that provides desirable overall properties when the two are combined.

In one aspect, a lithium-ion electrochemical cell is provided that includes a positive electrode comprising a mixed metal oxide having the formula, Liₐ[MnₓNi_{y}Co_{z}]O₂; a negative electrode comprising lithium titanate nanoparticles (Li₄Ti₅O₁₂); and an electrolyte; wherein 0.40≦a≦1.20, 0<x≦0.40, 0<y≦0.40, 0.55≦z≦0.95, and x+y+z=1.0.

In another aspect a method of making an electrochemical cell is provided that includes selecting a cathode that has a first cycle irreversible capacity of less than about 7% when cycled vs. lithium metal, selecting an anode that has a first cycle irreversible capacity of less than about 7% when cycled vs. lithium metal, and combining the cathode and the anode along with an electrolyte and a separator to form a cell.

In this disclosure:

“average particle size” refers the average size of the longest dimension of the particle;

“electrochemically active” refers to materials that can react or alloy with lithium;

“electrochemically inactive” refers to materials that do not react or alloy with lithium;

“lithiate” and “lithiation” refer to a process for adding lithium to an electrode material;

“charge” and “charging” refer to a process for providing electrochemical energy to a cell;

“delithiate” and “delithiation” refer to a process for removing lithium from an electrode material;

“discharge” and “discharging” refer to a process for removing electrochemical energy from a cell, e.g., when using the cell to perform desired work;

“dopant” refers to one or more metals added to the cathode or anode composition in an amount of equal to or less than 25mol %;

“positive electrode” refers to an electrode (often called a cathode) where electrochemical reduction and lithiation occurs during a discharging process; and

“negative electrode” refers to an electrode (often called an anode) where electrochemical oxidation and delithiation occurs during a discharging process;

“nano” refers to an average particle size of less than about 100 nm.

The provided lithium-ion electrochemical cells include lithium mixed metal oxide cathodes in which at least 55 mole percent (mol %) of the metal is cobalt and the anode is lithium titanate. These cells are designed to be compact, have high energy density, low irreversible capacity, and good thermal stability. Additionally, with the use of lithium titanate that has a potential as a negative electrode that is about 1.6 eV above Li/Li⁻, the cells do not plate out elemental lithium during the normal cycling process and therefore have reduced potential to produce thermal runaway reactions.

The above summary is not intended to describe each disclosed embodiment of every implementation of the present invention. The brief description of the drawing and the detailed description which follows more particularly exemplify illustrative embodiments.

### BRIEF DESCRIPTION OF THE DRAWINGS

FIG. 1 is a graph of the theoretical crystal density of Li[MnₓNi_{y}Co_{z}]O₂ with equal amounts of Mn and Ni and as a function of cobalt content.

FIG. 2 displays three graphs of the voltage (V) vs. specific capacity (mAh/g) of a half cell with a Li₄Ti₅O₁₂ electrode vs. Li metal, a half cell with an Li[Mn_{0.10}Ni_{0.10}Co_{0.80}]O₂ electrode vs. Li metal, and an electrochemical cell with a Li₄Ti₅O₁₂ anode and a Li[Mn_{0.10}Ni_{0.10}Co_{0.80}]O₂ cathode.

FIG. 3 displays three graphs of dQ/dV (mAh/(gV)) vs. voltage (V) for the same three cells in FIG. 2

FIG. 4 displays the specific discharge capacity (mAh/g) vs. cycle number for an electrochemical cell with a Li₄Ti₅O₁₂ anode and a Li[Mn_{0.10}Ni_{0.10}Co_{0.80}]O₂ cathode.

FIG. 5 displays three graphs of the voltage (V) vs. specific capacity (mAh/g) of three electrochemical coin cells all with a Li₄Ti₅O₁₂ anode and having a Li[Mn_{1/3}Ni_{1/3}Co_{1/3}]O₂, a Li[Mn_{1/5}Ni_{1/5}Co_{3/5}]O₂, and a Li[Mn_{1/6}Ni_{1/6}Co_{2/3}]O₂ cathode

### DETAILED DESCRIPTION

In the following description, reference is made to the accompanying set of drawings that form a part of the description hereof and in which are shown by way of illustration several specific embodiments. It is to be understood that other embodiments are contemplated and may be made without departing from the scope or spirit of the present invention. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

A lithium-ion electrochemical cell is provided that includes a positive electrode comprising a mixed metal oxide; a negative electrode comprising lithium titanate nanoparticles; and an electrolyte. The mixed metal oxide can have the formula Liₐ[MnₓNi_{y}Co_{z}]O₂, wherein 0.40≦a≦1.20, 0<x≦0.40, 0<y≦0.40, 0.55≦z≦0.95, and x+y+z=1.0. In some embodiments, 0.40≦a≦1.20, 0.50<x≦0.25, 0.50<y≦0.25, and 0.55≦z≦0.90. The cathode material can include particles of mixed metal oxide that can be nano-sized (average particle size of about 100 nm or less) which gives them high surface area. The provided lithium-ion electrochemical cell also includes a negative electrode that includes lithium titanate (Li₄Ti₅O₁₂) particles that can also be nanoparticles. There is an electrolyte used in the cell. Details are discussed below.

A positive electrode composition is provided that includes a plurality of particles that include lithium mixed metal oxides including at least manganese, nickel, and cobalt. Functionally, the particles, typically, include lithium metal oxides that work better as stable positive electrode materials at high voltages, such as voltages above 3.8 V vs. Li/Li⁺. The lithium metal oxide can be a replacement for LiCoO₂ in traditional lithium-ion electrochemical cells and can adopt the O3 layered structure that can be desirable for efficient lithiation and delithiation.

In some embodiments, the provided cathode materials can have the formula, Liₐ[MnₓNi_{y}Co_{z}]O₂ wherein 0.40≦a≦1.20, 0<x≦0.40, 0<y≦0.40, 0.55≦z≦0.95, and x+y+z=1.0, and can be prepared by a number of methods, exhibit good cell performance and appear to be much less reactive with electrolytes at high temperatures compared to LiCoO₂ when charged to a high voltage. Suitable lithium metal oxide materials are described, for example, in U.S. Pat. No. 6,964,828 (Lu et al.) and U.S. Pat. No. 7,368,071 (Dahn et al.); U.S. Pat. Publ. Nos. 2004/0179993; U.S. Pat. No. 7,211,237 (Eberman et al.); U.S. Pat. Publ. No. 2006/0147798 and U.S. Pat. No. 6,680,145 (both Obrovac et al.).

The cathode compositions may be synthesized by jet milling or by combining precursors of the metal elements (e.g., hydroxides, nitrates, and the like), followed by heating to generate the cathode composition. Heating is preferably conducted in air at temperatures of at least about 600° C., more preferably at least 800° C. In general, higher temperatures are preferred because they lead to materials with increased crystallinity. The ability to conduct the heating process in air is desirable because it obviates the need and associated expense of maintaining an inert atmosphere. Accordingly, the particular metal elements are selected such that they exhibit appropriate oxidation states in air at the desired synthesis temperature. Conversely, the synthesis temperature may be adjusted so that a particular metal element exists in a desired oxidation state in air at that temperature.

In some embodiments, the lithium mixed metal oxide compositions can preferably adopt an O3 or α-NaFeO₂ type layered structure that can be desirable for efficient lithiation and delithiation. These materials are well known in the art and are disclosed, for example, in U.S. Pat. Nos. 5,858,324; 5,900,385 (both Dahn et al.); and U.S. Pat. No. 6,964,828 (Lu et al.). In some embodiments, the provided cathode compositions can include transition metals selected from manganese (Mn), nickel (Ni), and cobalt (Co). The amount of Mn can range from greater than 0 to about 40 mole percent (mol %), from greater than 0 to about 20 mol %, or from greater than zero to about 10 mol % based upon the total mass of the cathode composition, excluding lithium and oxygen. The amount of Ni can range from greater than 0 to about 40 mol %, from greater than 0 to about 20 mol %, or from greater than zero to about 10 mol % based upon the total mass of the cathode composition, excluding lithium and oxygen. The amount of Co can range from greater than about 55 mol % to about 95 mol %, from greater than about 65 mol % to about 95 mol %, from greater than about 80 mol % to about 95 mol %, or even from greater than about 90 mol % to about 95 mol % of the composition excluding lithium and oxygen. In some embodiments, the lithium metal oxide can include additional metals. For example, the lithium mixed metal oxide can include one or more additional metals as dopants. Exemplary metals include Al, Mg, Zr, Fe, Cu, Zn, V, or Ti. It has been shown by Jouanneau et al., J. Electrochem. Soc., 150 (10), A1299 (2003) and Jiang et al., J. Electrochem. Soc., 152 (3), A566 (2005) that the addition of a small amount of transition metals such as manganese and nickel into the LiCoO₂ structure significantly increases the thermal stability. Both of these papers show that lithium mixed metal oxides with about 90 mole percent cobalt have much higher thermal stability than pure LiCoO₂.

In some other embodiments, the lithium mixed metal oxides can be aluminum-doped lithium transition metal oxides as disclosed, for example, in U.S. Pat. Publ. No. 2006/0068289 (Paulsen et al.) or lithium transition metal oxides with a gradient of metal compositions as disclosed, for example, in U.S. Pat. Publ. No. 2006/0105239 (Paulsen et al.) Other mixed metal oxide disclosures include U.S. Pat. Publ. Nos. 2007/0292761, 2007/0298512 and 2008/32196 (all Paulsen et al.)

Lithium metal oxide particles can be in the form of a single phase having an O3 (α-NaFeO₂) crystal structure. The particles may have a maximum average dimension that is no greater than 60 micrometers, no greater than 40 micrometers, or no greater than 20 micrometers. The powders may for example have a maximum average particle diameter that is submicron, at least 1 micrometer, at least 2 micrometers, at least 5 micrometers, or at least 10 micrometers. For example, suitable powders often have a maximum average dimension of 1 to 60 micrometers, 10 to 60 micrometers, 20 to 60 micrometers, 40 to 60 micrometers, 1 to 40 micrometers, 2 to 40 micrometers, 10 to 40 micrometers, 5 to 20 micrometers, or 10 to 20 micrometers. The powdered materials may contain optional matrix formers within powder particles. Each phase originally present in the particle (i.e., before a first lithiation) may be in contact with the other phases in the particle. In some embodiments the average diameter of particles of the mixed metal oxide materials can be from about 2 μm to about 25 μm. In other embodiments, the average particle size can be less than about 1000 nm, less than about 500 nm, less than about 250 nm, less than about 100 nm, or less than about 50 nm.

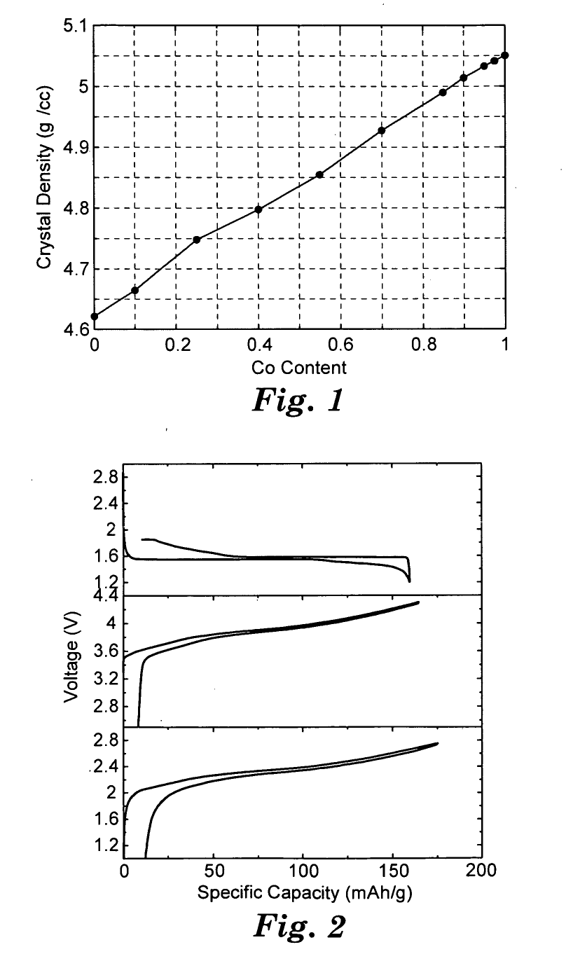

The theoretical crystal density of Li[MnₓNi_{y}Co_{z}]O₂ for x=y has been calculated from the lattice constant data in a reference by Lu et al., J. Electrochem. Soc., 149 (10), A1332 (2002). The data are shown in FIG. 1 and show that lithium mixed metal oxides with manganese, nickel, and cobalt have crystal densities that increase with increasing cobalt content. They range from about 4.62 g/cm³ for Li[Mn_{0.5}Ni_{0.5}Co_{0.0}]O₂ 5.05 g/cm³ for LiCoO₂. Thus, lithium mixed metal oxides with higher cobalt content will have higher energy density.

The provided electrochemical cells include a negative electrode that includes lithium titanate nanoparticles. The lithium titanate can have the formula, Li₄Ti₅O₁₂ or Li₇Ti₅O₁₂. The negative electrode material can have the same particle dimensions as those stated for the lithium mixed metal oxide electrodes. The chemical potential of Li atoms in charged Li₄Ti₅O₁₂ (Li₇Ti₅O₁₂) is aboutl.5 eV vs. Li/Li⁺, which is much lower than the chemical potential of lithium in graphite (0.05 eV vs. Li/Li⁺). The output voltage of, for example, an electrochemical cell with a LiCoO₂ positive electrode and a Li₄Ti₅O₁₂ negative electrode has an output voltage that is approximately 1.45 V lower than the output voltage of a commercial graphite/LiCoO₂ cell. Additionally, Li₄Ti₅O₁₂ is a zero strain material since its lattice constant is almost invariant during charge which leads to good electrochemical performance. Jiang et al. (J. Electrochem. Soc., 151(12), A2082 (2004)) have disclosed data comparing the reactions of Li₄Ti₅O₁₂ with solvent or electrolyte compared to discharged graphite (MCMB—mesocarbon microbeads) and have found that safer lithium-ion electrochemical cells can be built using Li₄Ti₅O₁₂ as a negative electrode in place of lithium cobalt oxide.

One way to improve the safety of lithium-ion electrochemical cells is to change the negative electrode material. Jiang and Dahn (J. Electrochem. Soc., 153(2), A310 (2006) studied the reaction of various anode materials used in electrochemical cells in terms of their reaction with nonaqueous solvents such as those used in commercial lithium-ion electrochemical cells using accelerating rate calorimetry (ARC). They compare the reaction of MCMB negative electrodes with nonaqueous solvent to that of Li₄Ti₅O₁₂ negative electrodes with nonaqueous solvent and found that the heat of reaction per mole of lithium was reduced by about a factor of two. This has suggested that the safety of lithium ion electrochemical cells can be improved by increasing the average potential of the negative electrode material, keeping other factors (like specific surface area) constant. Additionally the irreversible capacity loss in the first cycle for a Li₄Ti₅O₁₂ electrode has been found to be about 6%.

The use of Li₄Ti₅O₁₂ negative electrodes in a lithium-ion cell can significantly decrease the cell energy density (Wh/g) since a cell with a Li₄Ti₅O₁₂ negative electrode has an average lower cell voltage approximately 1.45 V than that a cell with a graphite negative electrode. However the average higher voltage of Li₄Ti₅O₁₂ (1.5 eV vs. Li/Li⁺) compared with that of graphite (0.05 eV vs. Li/Li⁺) can allow for much higher thermal stability than graphite. Furthermore, there is no significant reactivity between the charged Li₄Ti₅O₁₂ and LiPF₆ in an electrolyte until 220° C., compared to an 80° C. onset temperature of charged graphite in the same electrolyte from accelerating rate calorimetry studies as shown by Jiang et al., (J. Electrochem. Soc., 151(12), A2082 (2004)).

To make an electrode from the provided electrode compositions, the provided electrode composition, any selected additives such as binders, conductive diluents, fillers, adhesion promoters, thickening agents for coating viscosity modification such as carboxymethylcellulose, and other additives known by those skilled in the art can be mixed in a suitable coating solvent such as water or N-methylpyrrolidinone (NMP) to form a coating dispersion or coating mixture. The coating dispersion or coating mixture can be mixed thoroughly and then applied to a foil current collector by any appropriate coating technique such as knife coating, notched bar coating, dip coating, spray coating, electrospray coating, or gravure coating. The current collectors are typically thin foils of conductive metals such as, for example, copper, aluminum, stainless steel, or nickel foil. The slurry is coated onto the current collector foil and then allowed to dry in air followed usually by drying in a heated oven, typically at about 80° C. to about 300° C. for about an hour to remove all of the solvent.

Electrodes made from the provided electrode compositions can include a binder. Exemplary polymer binders include polyolefins such as those prepared from ethylene, propylene, or butylene monomers; fluorinated polyolefins such as those prepared from vinylidene fluoride monomers; perfluorinated polyolefins such as those prepared from hexafluoropropylene monomer; perfluorinated poly(alkyl vinyl ethers); perfluorinated poly(alkoxy vinyl ethers); aromatic, aliphatic, or cycloaliphatic polyimides, or combinations thereof. Specific examples of polymer binders include polymers or copolymers of vinylidene fluoride, tetrafluoroethylene, and propylene; and copolymers of vinylidene fluoride and hexafluoropropylene. Other binders that can be used in the provided electrode compositions include lithium polyacrylate which has been shown to have increased capacity retention and cycle life with lithium metal oxide cathodes as disclosed, for example, in co-owned application, U.S. Pat. Publ. No. 2008/0187838 (Le et al.). Lithium polyacrylate can be made from poly(acrylic acid) that is neutralized with lithium hydroxide. Le et al. discloses that poly(acrylic acid) includes any polymer or copolymer of acrylic acid or methacrylic acid or their derivatives where at least 50 mol %, at least 60 mol %, at least 70 mol %, at least 80 mol %, or at least 90 mol % of the copolymer is made using acrylic acid or methacrylic acid. Useful monomers that can be used to form these copolymers include, for example, alkyl esters of acrylic or methacrylic acid that have alkyl groups with 1-12 carbon atoms (branched or unbranched), acrylonitriles, acrylamides, N-alkyl acrylamides, N,N-dialkylacrylamides, and hydroxyalkylacrylates.

Embodiments of the provided electrode compositions can also include an electrically conductive diluent that can facilitate electron transfer from the powdered cathode composition to a current collector. Electrically conductive diluents include, but are not limited to, carbon (e.g., carbon black for negative electrodes and carbon black, flake graphite and the like for positive electrodes), metal, metal nitrides, metal carbides, metal silicides, and metal borides. Representative electrically conductive carbon diluents include carbon blacks such as SUPER P and SUPER S carbon blacks (both from MMM Carbon, Belgium), SHAWANIGAN BLACK (Chevron Chemical Co., Houston, Tex.), acetylene black, furnace black, lamp black, graphite, carbon fibers and combinations thereof.

In some embodiments, the provided electrode compositions can include an adhesion promoter that promotes adhesion of the cathode composition and/or electrically conductive diluent to the binder. The combination of an adhesion promoter and binder can help the cathode composition better accommodate volume changes that can occur in the powdered material during repeated lithiation/delithiation cycles. Binders can offer sufficiently good adhesion to metals and alloys so that addition of an adhesion promoter may not be needed. If used, an adhesion promoter can be made a part of a lithium polysulfonate fluoropolymer binder (e.g., in the form of an added functional group), such as those disclosed in PCT Pat. Publ. No. WO2008/097723 (Pham), can be a coating on the powdered material, can be added to the electrically conductive diluent, or can be a combination thereof. Examples of useful adhesion promoters include silanes, titanates, and phosphonates as described, for example, in U.S. Pat. No. 7,341,804 (Christensen).

In nearly every modern application of electronics, there is a trend towards higher energy density in smaller spaces. The energy density and dissipation of heat is an important consideration to designers. In portable and hand-held devices, for example, the desire to miniaturize while adding functionality increases the thermal power density making the thermal stability of the electrochemical cells within them more challenging. As computational power increases within desktop computers, datacenters and telecommunications centers, so does the heat output. Power electronic devices such as the traction inverters in plug-in electric or hybrid vehicles, wind turbines, train engines, generators and various industrial processes make use of transistors that operate at ever higher currents and heat fluxes. So the design of electrochemical cells that can be used in high power lithium-ion cells so that they have high charge-discharge rate capability, excellent thermal stability, and low irreversible capacity are important considerations.

The irreversible capacity (%) of several different Liₐ[MnₓNi_{y}Co_{z}]O₂ materials at different cobalt concentrations was measured by making positive electrodes out of the material and cycling coin cells from 2.5 V to 4.3 V vs. Li metal at a rate of 15 mA/g. coin-type test cells can be built in 2325-size coin cell hardware as described in A. M. Wilson and J. R. Dahn, J. Electrochem. Soc., 142, 326-332 (1995). The first cycle irreversible capacities are shown in Table I.

TABLE I
Irreversible Capacities of Positive Electrode Materials

| | Irreversible |
|---|---|
| Materials | Capacity (%) |
| Li[Mn_{0.42}Ni_{0.42}Co_{0.16}]O₂ | 14% |
| Li[Mn_{1/3}Ni_{1/3}Co_{1/3}]O₂ | 11% |
| Li[Mn_{0.20}Ni_{0.20}Co_{0.60}]O₂ | 7% |
| Li[Mn_{1/6}Ni_{1/6}Co_{2/3}]O₂ | 6% |
| Li[Mn_{0.10}Ni_{0.10}Co_{0.80}]O₂ | 6% |
| LiCoO₂ | 4% |

Thus, to design lithium-ion electrochemical cells with high charge-discharge rates, low irreversible capacity, and good thermal stability the following parameters can be considered. For high charge-discharge rates, a layered structure, such as can exist in lithium transition metal oxides, is desirable. To reduce irreversible capacity loss for the cell, it is desirable to use a cathode material and an anode material that exhibit low irreversible capacity. Lithium mixed metal oxides that include nickel and manganese and that have high amounts of cobalt (about 55 mol % or greater) have relatively low irreversible capacities of less than about 7%. And lithium titanate, as an anode material, also has relatively low irreversible capacity of about 6%. So the combination of a lithium mixed metal oxide cathode material with high cobalt content and a lithium titanate anode can produce an electrochemical cell with low irreversible capacity (can be about 7% or less). Finally, the use of lithium titanate as the anode with a chemical potential much lower than graphite and the use of a high cobalt lithium mixed metal oxide as the cathode can produce an electrochemical cell with good thermal stability.

Objects and advantages of this invention are further illustrated by the following examples, but the particular materials and amounts thereof recited in these examples, as well as other conditions and details, should not be construed to unduly limit this invention. All references cited within this disclosure are herein incorporated by reference in their entirety.

### EXAMPLES

### Materials

Nano-size Li₄Ti₅O₁₂ was obtained from NEI Corporation.
LiCoO₂ was obtained from Nippon Chemical Corporation.
Li[Mn_{0.42}Ni_{0.42}Co_{0.16}]O₂ and Li[Mn_{1/3}Ni_{1/3}Co_{1/3}]O₂ were obtained from 3M Company, St. Paul, Minn. as BC-723 Cathode Material and BC-618 Cathode Material respectively.

### Preparative Example 1

### Li[Mn_{0.1}Ni_{0.1}Co_{0.8}]O₂

26.28 g NiSO₄.6H₂O (available from Aldrich Chemical, Milwaukee, Wis.), 16.90 g MnSO₄.H₂O (Aldrich), and 224.88 g of CoSO₄.7H₂O were dissolved in distilled water in a 500 ml volumetric flask to form a solution that was 2M in transition metal sulfates. Mn_{0.1}Ni_{0.1}Co_{0.8}(OH)₂ was prepared by coprecipitation from the transition metal sulfate solution by addition of 3.7 M NaOH solution until the pH of the solution reached 10. The precipitate was recovered by filtration and washed repeatedly using vacuum filtration. The precipitate was then placed in a box furnace set to 120° C. to dry. The precipitate was ground by a coffee grinder for approximate for 15 seconds. After grinding, 10.00 g of precipitate powder (containing about 3% moisture) was dry mixed with 4.634 g of LiOH.H₂O. The mixture powder was heated to 900° C. at 4° C./min and soaked at that temperature for 4 hours. The powder was then cooled down to room temperature at the same rate. After grinding in a coffee grinder, the powder was passed through a 106 μm sieve.

### Preparatory Example 2

### Li[Mn_{0.2}Ni_{0.2}Co_{0.6}]O₂

Li[Mn_{0.2}Ni_{0.2}Co_{0.6}]O₂ was prepared according to Preparatory Example 1 with stoichiometries of the precursors adjusted accordingly.

### Electrochemical Cell Preparation

### Thin Film Cathode Electrodes for Electrochemical Tests

Electrodes were prepared as follows: 10% polyvinylidene difluoride (PVDF, Aldrich Chemical Co.) in N-methyl pyrrolidinone solution was prepared by dissolving about 10 g PVDF into 90 g of NMP solution. 7.33 g Super-P carbon (MMM Carbon, Belgium), 73.33 g of 10 weight percent (wt %) PVDF in NMP solution, and 200 g NMP were mixed in a glass jar. The mixed solution contained about 2.6 wt % each of PVDF and Super-P carbon in NMP. 5.25 g of the solution was mixed with 2.5 g cathode material using a Mazerustar mixer machine (Kurabo Industries Ltd., Japan) for 8 minutes to form uniform slurry. The slurry was then spread onto a thin aluminum foil on a glass plate using a 0.25 mm (0.010″) notch-bar spreader. The coated electrode was then dried in an 80° C. oven for around 10 minutes. The electrode was then put into a 120° C. vacuum oven for 1 hour to evaporate NMP and moisture. The dry electrode contained about 90 wt % cathode material and 5 wt % PVDF and Super P each. The mass loading of the active cathode material was around 8 mg/cm².

Thin films of Li₄Ti₅O₁₂ anode electrode containing 90 wt % graphite and 5 wt % each of PVDF and Super P were coated on Al foil in similar way as the cathode thin film electrode.

### Cell Construction

Coin cells were fabricated with the resulting cathode electrode and Li metal anode or graphite thin film electrode as described in A. M. Wilson and J. R. Dahn, J. Electrochem. Soc., 142, 326-332 (1995) using 2325-size (23 mm diameter and 2.5 mm thickness) coin-cell hardware in a dry room. The separator, microporous polypropylene was available from Tonen General, Tokyo, Japan and had a thickness around 20 um. The electrolyte used in cell was 1 M solution of LiPF₆ (Stella Chemifa Corporation, Japan) dissolved in a 1:2 volume mixture of ethylene carbonate (EC) (Aldrich Chemical Co.) and diethyl carbonate (DEC) (Aldrich Chemical Co.).

### Test Results

FIG. 2 contains three graphs of the first cycle voltage (V) vs. specific capacity (mAh/g) of a half cell with a Li₄Ti₅O₁₂ electrode vs. Li metal (top panel) from 1.20 V to 1.25 V, a half cell with an Li[Mn_{0.10}Ni_{0.10}Co_{0.80}]O₂ electrode vs. Li metal (middle panel) from 2.50 V to 4.30 V, and an electrochemical cell with a Li₄Ti₅O₁₂ anode and a Li[Mn_{0.10}Ni_{0.10}Co_{0.80}]O₂ cathode (bottom panel) from 1.00V to 2.75V. The coin cells were cycled using a 15 mA/g charge/discharge current. The graphs displayed are of the first cycle. FIG. 2 (top panel) shows that Li₄Ti₅O₁₂ has a potential of about 1.55 V vs. Li/Li⁺ with very little first cycle irreversible capacity loss. Li[Mn_{0.10}Ni_{0.10}Co_{0.80}]O₂ has a potential of about 4.0 V vs. Li/Li⁺ (middle panel), a specific capacity of about 165 mAh/g and shows about 10 mAh/g irreversible capacity loss or about 6% loss. The combined cell (bottom panel) cycles with a combination of the two half cell properties with a voltage of about 2.4 V vs. Li/Li⁺ and a first cycle loss of about 12 mAh/g or about 6.8% loss.

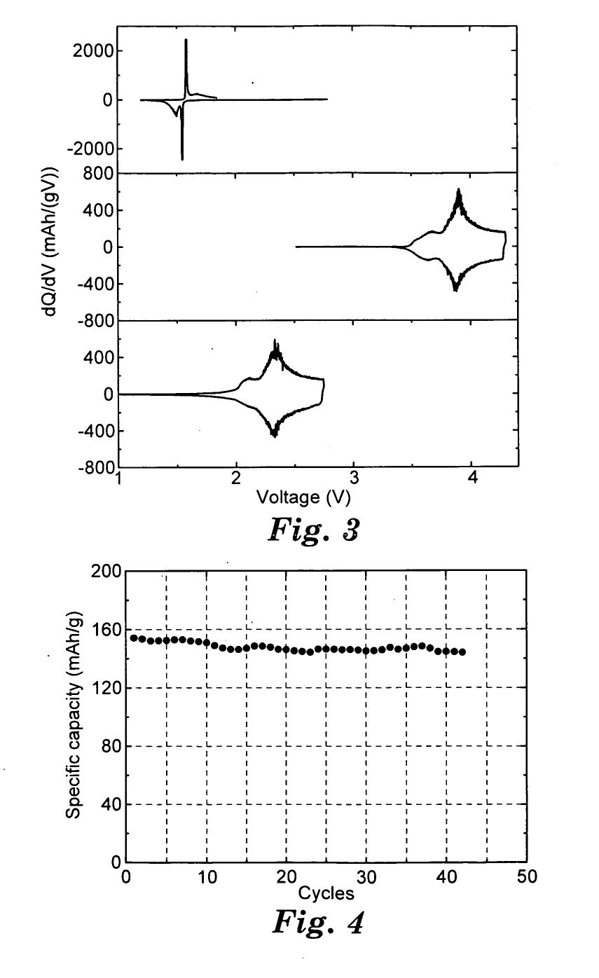

FIG. 3 shows plots of dQ/dV of the same coin cells as shown in FIG. 2. The combined electrochemical cell (bottom panel) has a voltage of about 2.4 V. The cycle rate was 15 mA/g for the first two cycles and then 40 mA/g for later cycles. This electrochemical cell was cycled for over 40 cycles as shown in FIG. 4 with very little specific capacity loss. The initial specific capacity was about 155 mAh/g and after 40 charge/discharge cycles the specific capacity of the cell was about 145 mAh/g which is a 94% retention in capacity.

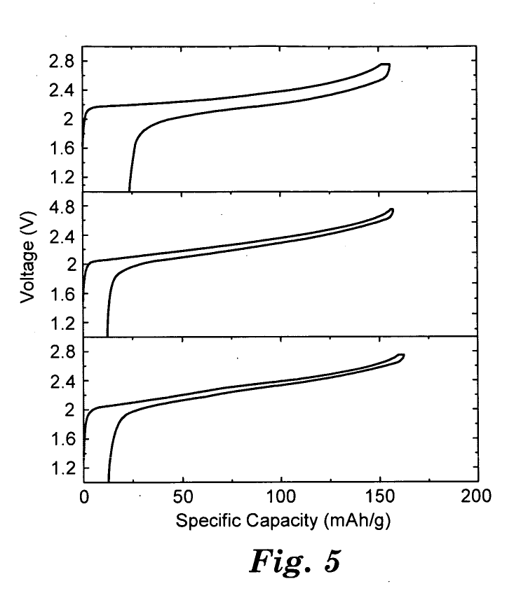

FIG. 5 displays the voltage (1.00 V to 2.75 V) vs. specific capacity curves for electrochemical cells having a Li₄Ti₅O₁₂ anode and a Li[Mn_{1/3}Ni_{1/3}Co_{1/3}]O₂ cathode (to panel), a Li[Mn_{1/5}Ni_{1/5}Co_{3/5}]O₂ cathode (middle panel), and a Li[Mn_{1/6}Ni_{1/6}Co_{2/3}]O₂ cathode (bottom panel) in the first cycle. This graph demonstrates that cells that contain cathodes with more cobalt have lower irreversible capacity loss as also displayed in Table I.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows. All references cited in this disclosure are herein incorporated by reference in their entirety.

What is claimed is:

1. A lithium-ion electrochemical cell comprising:
a positive electrode comprising a mixed metal oxide having the formula, Liₐ[MnₓNi_{y}Co_{z}]O₂;
an negative electrode comprising lithium titanate nanoparticles; and
wherein 0.40≦a≦1.20, 0<x≦0.40, 021 y≦0.40, 0.55≦z≦0.95, and x+y+z=1.0.

2. A lithium-ion electrochemical cell according to claim 1, wherein 0.40≦a≦1.20, 0.50<x≦0.25, 0.50<y≦0.25, and 0.55≦z≦0.90.

3. A lithium-ion electrochemical cell according to claim 1, wherein the value of x is about equal to the value of y.

4. A lithium-ion electrochemical cell according to claim 3 wherein 0.55≦z≦0.85.

5. A lithium-ion electrochemical cell according to claim 4 wherein x has a value selected from about 0.1, about 0.167, and about 0.2.

6. A lithium-ion electrochemical cell according to claim 1, wherein the positive electrode, the negative electrode, or both the positive and the negative electrodes further comprise an additional metal.

7. A lithium-ion electrochemical cell according to claim 6, wherein the positive electrode comprises an additional metal selected from Al, Mg, Zr, Fe, Cu, Zn, V, Ti, and combinations thereof.

8. A lithium-ion electrochemical cell according to claim 6, wherein the negative electrode comprises an additional metal selected from Si, Sn, Al, Ga, Ge, In, Bi, Pb, Zn, Cd, Hg, Sb, and combinations thereof.

9. A lithium-ion electrochemical cell according to claim 1, wherein the negative electrode exhibits an irreversible capacity loss of less than about 7% during an initial charge-discharge cycle from 2.0 V to 1.2 V at about a 15 mA/g charge/discharge current.

10. A lithium-ion electrochemical cell according to claim 1, wherein the positive electrode exhibits an irreversible capacity loss of less than about 7% during an initial charge-discharge cycle from 2.5 V to 4.3 V at about a 15 mA/g charge/discharge current.

11. A lithium-ion electrochemical cell according to claim 1, wherein the cell exhibits an irreversible capacity loss of less than about 7% during an initial charge-discharge cycle from 1.00 V to 2.75 V at about a 15 mA/g charge/discharge current.

12. A lithium-ion electrochemical cell according to claim 1, wherein the initial cycle irreversible capacity loss of the cathode is less than or equal to the initial cycle irreversible capacity loss of the anode when cycled under the same conditions.

13. A lithium-ion electrochemical cell according to claim 1, wherein the mixed metal oxide has a crystal density of greater than about 4.85 g/cc.

14. A lithium-ion electrochemical cell according to claim 1, wherein the lithium mixed metal oxide includes aluminum as a dopant.

15. A method of making an electrochemical cell comprising:
selecting a cathode that has a first cycle irreversible capacity of less than about 7% when cycled vs. lithium metal;
selecting an anode that has a first cycle irreversible capacity of less than about 7% when cycled vs. lithium metal; and
combining the cathode and the anode along with an electrolyte and a separator to form a cell.

16. A method of making an electrochemical cell according to claim 15, wherein the cathode comprises a lithium mixed metal oxide and the anode comprises lithium titanate.

17. A method of making an electrochemical cell according to claim 16, wherein the amount of cobalt in the lithium mixed metal oxide is greater than about 55 mol % and nickel and manganese are also present.
